(19) United States
(12) Patent Application Publication
(10) Pub. No.: US 2025/0225406 A1
(43) Pub. Date: Jul. 10, 2025

(54) PERFORMANT COLLABORATIVE TRANSFER LEARNING BETWEEN CLOUD STORAGE AND CLOUD COMPUTING

(71) Applicant: Huawei Cloud Computing Technologies Co., Ltd., Gui‘an New District (CN)

(72) Inventors: Arsany Guirguis, Munich (DE); Florin Dinu, Munich (DE); Quoc Do Le, Munich (DE); Javier Picorel, Munich (DE); Rachid Guerraoui, Munich (DE)

(73) Assignee: Huawei Cloud Computing Technologies Co., Ltd., Gui‘an New District (CN)

(21) Appl. No.: 19/017,118

(22) Filed: Jan. 10, 2025

Related U.S. Application Data
(63) Continuation of application No. PCT/EP2022/069331, filed on Jul. 11, 2022.

(51) Int. Cl. G06N 3/096; G06N 3/10

(52) U.S. Cl. CPC G06N 3/096; G06N 3/10

(57) ABSTRACT

A computing apparatus is provided comprising a client and a server. The computing apparatus is configured to: obtain a machine learning code; split the machine learning code into a first part and a second part; execute the first part of the machine learning code on the server; execute the second part of the machine learning code on the client; and output a result of the machine learning code. In this way, the machine learning code may be split and executed over both the client and the server in an efficient way.

### CROSS-REFERENCE TO RELATED APPLICATIONS

This application is a continuation of International Application No. PCT/EP2022/069331, filed on Jul. 11, 2022, the disclosure of which is hereby incorporated by reference in its entirety.

### FIELD OF THE INVENTION

Embodiments of this application relate to a machine learning apparatus and method for executing machine learning code over a client and a server.

### BACKGROUND

The computational capabilities of disaggregated cloud object stores (COS) are increasing. Users may no longer be restricted to running a limited subset of structured query language (SQL) next to storage. Users may perform complex tasks, such as image processing, inside the COS, and some providers have even started provisioning their COS with graphical processing units (GPU). However, there are fundamental constraints that can remain, such as: (i) the connection between the cloud network and the compute tier may cause a bottleneck, and (ii) the COS computational resources may be at a premium, despite the upgrade, because they are only meant to complement the compute tier and not replace it.

US10,649,988 B1, US10,904,298 B2, US2020/0401886 A1, and US2019/0250998A1 describe building machine learning (ML) systems when a storage tier is involved.

US10,649,988B1 provides very high-level guidelines on an optimization module (e.g. resource-based admission control) and on a monitoring module (e.g. identifies bottlenecks and reconfigures resource allocations accordingly). US10,904,298B2 and US2019/0250998A1 focus on a different context and do not focus on improving transfer learning TL processing. Meanwhile, US2020/0401886A1 may not provide a solution for reducing network traffic between a storage tier and a compute tier in a cloud.

Additionally, US11,003,988B2, WO2016/118257A1, and US2020/0210834A1 describe distributed ML systems and opportunities for splitting ML computations. US11,003,988B2 may improve a deep learning medical system, by using TL and other deep learning techniques. WO2016/118257A1 describes a method for compressing an ML network, such as a neural network. US 2020/0210834A1 describes methods to partition a DNN across heterogeneous LAN devices, based on DNN characterization, in order to mitigate LAN network bottleneck.

FIG. 1 schematically illustrates a computing apparatus of the prior art. The computing apparatus 100 may comprise a compute tier 101 and an object store 102. The compute tier 101 may comprise a processor 103 which may execute a machine learning code 104. The object store 102 may comprise a memory 105. The object store 102 may transfer large amounts of data 106 to the compute tier 106.

The prior art may fail to reduce the bottleneck between the client and the server. The prior art may also fail to cope with concurrent inputs of machine learning code.

It is desirable to develop an apparatus and method that overcomes the above problems.

### SUMMARY

According to a first aspect, a computing apparatus comprising a client and a server is provided. The client and/or the server comprises one or more processors and a memory storing in non-transient form data defining program code executable by the one or more processors, wherein the program code, when executed by the one or more processors, causes the computing apparatus to: obtain a machine learning code: split the machine learning code into a first part and a second part: execute the first part of the machine learning code on the server: execute the second part of the machine learning code on the client; and output a result of the machine learning code. By splitting the machine learning code into a first part and a second part, this may enable the machine learning code to be executed over both the client and the server in an efficient way.

In some implementations, the first part of the machine learning code comprises at least part of an inference part of the machine learning code. In this way, more of the demanding part of the machine learning code may be carried out on the server, which may be more efficient.

In some implementations, the first part of the machine learning code comprises all of the inference part of the machine learning code. In this way, all of the demanding part of the machine learning code may be carried out on the server, which may be more efficient.

In some implementations, the second part of the machine learning code comprises all of the training part of the machine learning code. In this way, the data transfer between the server and the client may be reduced, which may reduce the load on the bandwidth of the network.

In some implementations, the machine learning code is a transfer learning code. In this way, the apparatus may use the knowledge learnt from one training context and re-use it in a related training context. In the related context there may be both inference and re-training.

In some implementations, the apparatus is configured to split the machine learning code in dependence on one or more characteristics of the machine learning code. In this way. the demands, for example on the memory, of the machine learning code may be split efficiently between the client and the server.

In some implementations, the apparatus is configured to execute the first part of the machine learning code for a synthesized data sample to generate a sample output, and split the machine learning code in dependence on the sample output. In this way, the apparatus may test the output demands of the machine learning code, so that the machine learning code may be split efficiently between the client and the server.

In some implementations, the apparatus is configured to split the machine learning code in dependence on one or more characteristics of the computing apparatus. In this way, the capacity, for example the memory, of the computing apparatus may be considered to efficiently split the machine learning code between the client and the server.

In some implementations, the apparatus is configured to split the machine learning code in dependence on an assessment between the sample output and the bandwidth of a network that connects the client and the server. In this way, the capacity of the bandwidth and the demands of the output of the machine learning code may be considered to efficiently split the machine learning code between the client and the server.

In some implementations, the apparatus is configured to control the batch size of the first part of the machine learning code.

In some implementations, the apparatus is configured to control the batch size of the first part of the machine learning code in dependence on one or more of: the memory of the server which would be occupied by the input and the output of the first part of the machine learning code; and the memory of the server which would be occupied by the weights of the machine learning code.

In some implementations, the apparatus is configured to obtain one or more subsequent machine learning codes. In this way, multiple users may be able to submit machine learning code, sequentially and/or concurrently, to be executed by the computing apparatus.

In some implementations, the apparatus is configured to individually control the batch size of the first part of each of the machine learning codes. In this way, the computing apparatus, in particular the server, may be able to prioritise and/or optimise the execution of multiple machine learning codes, sequentially and/or concurrently.

In some implementations, the apparatus is configured to individually control the batch size of the first part of each of the machine learning codes in dependence on one or more of: the memory of the server which would be occupied by the input and the output of the first part of each of the machine learning codes; and the memory of the server which would be occupied by the weights of each of the machine learning codes.

In some implementations, the machine learning code is obtained from a user, and/or the result of the machine learning code is outputted to the user. In this way, a user may submit a machine learning code to be executed by the computing apparatus, and receive the output of the machine learning code from the computing apparatus.

According to a second aspect, there is provided a method for executing machine learning code, the method comprising steps of: obtaining a machine learning code: splitting the machine learning code into a first part and a second part: executing the first part of the machine learning code on a server: executing the second part of the machine learning code on a client; and outputting a result of the machine learning code. By splitting the machine learning code into a first part and a second part, this may enable the machine learning code to be executed over both the client and the server in an efficient way.

### BRIEF DESCRIPTION OF THE FIGURES

The present disclosure will now be described by way of example with reference to the accompanying drawings. In the drawings:

FIG. 1 schematically illustrates a computing apparatus of the prior art.

FIG. 2 schematically illustrates a computing apparatus of a first embodiment of the present disclosure.

FIG. 3A schematically illustrates a computing apparatus of an embodiment of the present disclosure.

FIG. 3B schematically illustrates a computing apparatus of an embodiment of the present disclosure.

FIG. 3C schematically illustrates a computing apparatus of an embodiment of the present disclosure.

FIG. 4 schematically illustrates a computing apparatus according to an embodiment of the present disclosure.

FIG. 5 shows a computer implemented method for executing machine learning code according to an embodiment of the present disclosure.

FIG. 6 shows an apparatus configured to perform the methods described herein according to an embodiment of the present disclosure.

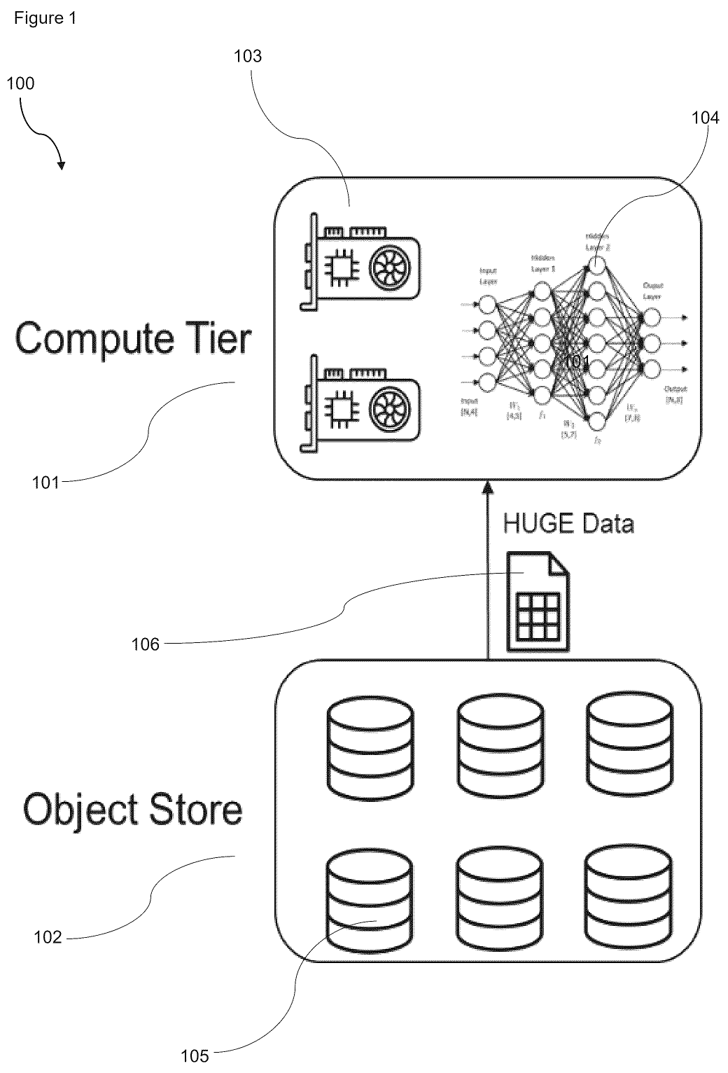

### DETAILED DESCRIPTION

The apparatuses and methods described herein concern executing a machine learning code.

Embodiments of the present disclosure may solve one or more of the problems previously mentioned by splitting the machine learning code into a first part and a second part, executing the first part of the machine learning code on a server, and executing the second part of the machine learning code on a client. This may enable the machine learning code to be split and executed over both the client and the server in an efficient way.

Each of the embodiments share common features as well as differing features, the details of which are described herein.

The present system may utilise the unique structure of transfer learning (TL), a combination of feature extraction, also known as inference, and training, to flexibly bypass the aforementioned problems and improve both client and operator-centric metrics. This present system may provide methods and techniques for TL that spans the compute and the COS tier, and may enable significant improvements while remaining completely transparent to the user.

The present system may provide mechanisms to process TL computation faster in a cloud or a data centre environment. In particular, the ML training may be split across both compute and storage. This may reduce the data moving between the compute and storage.

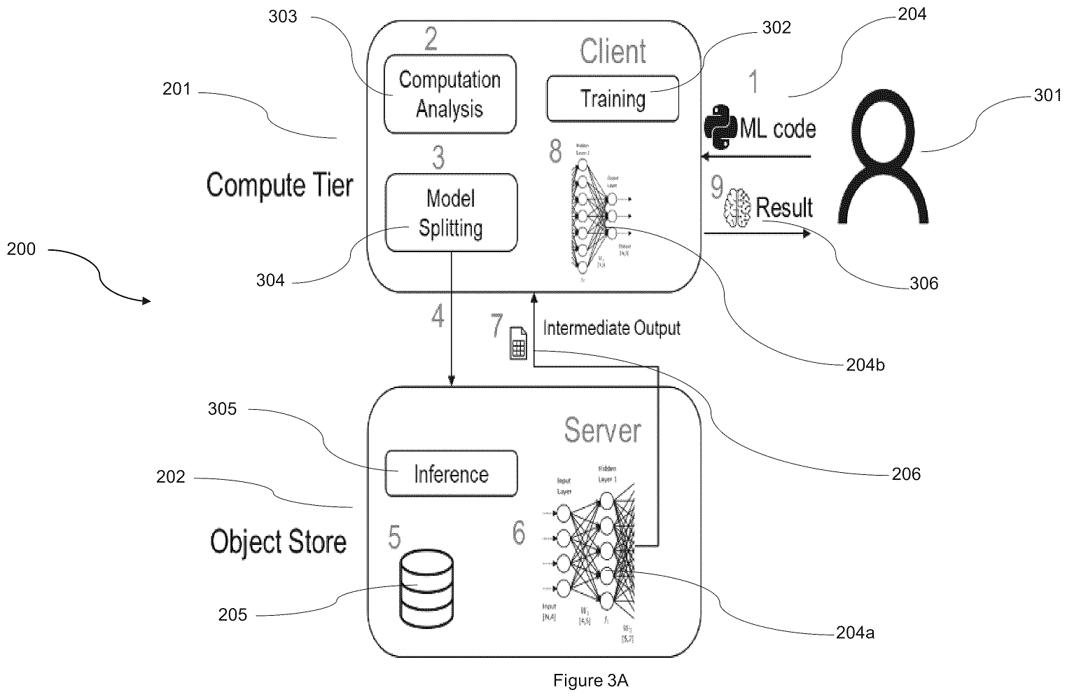

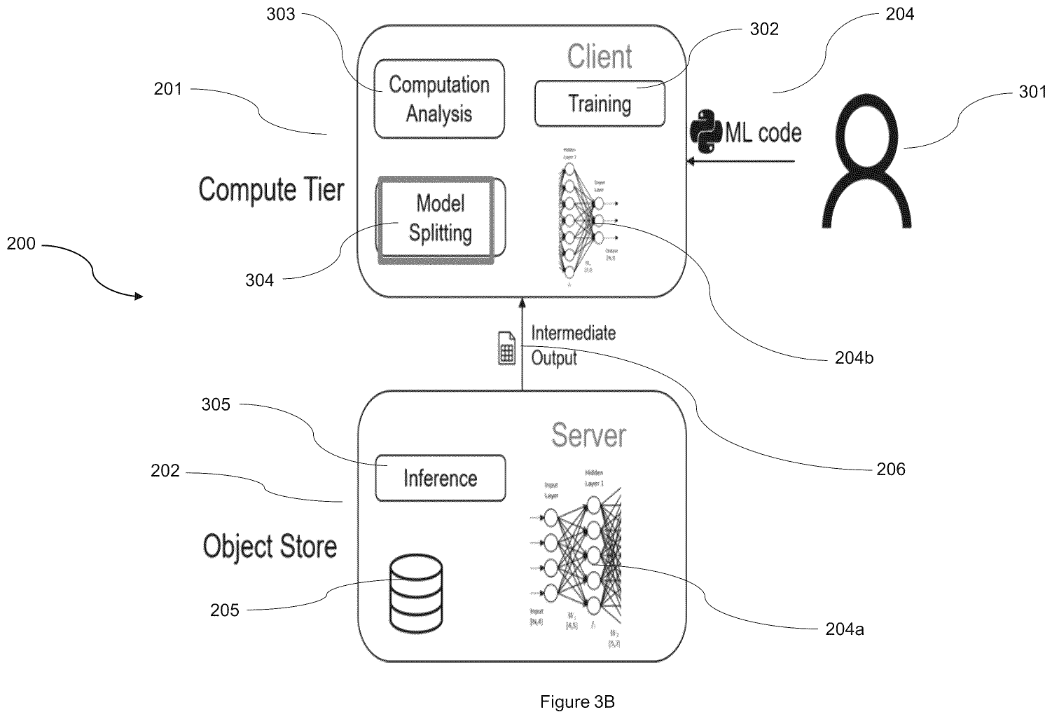

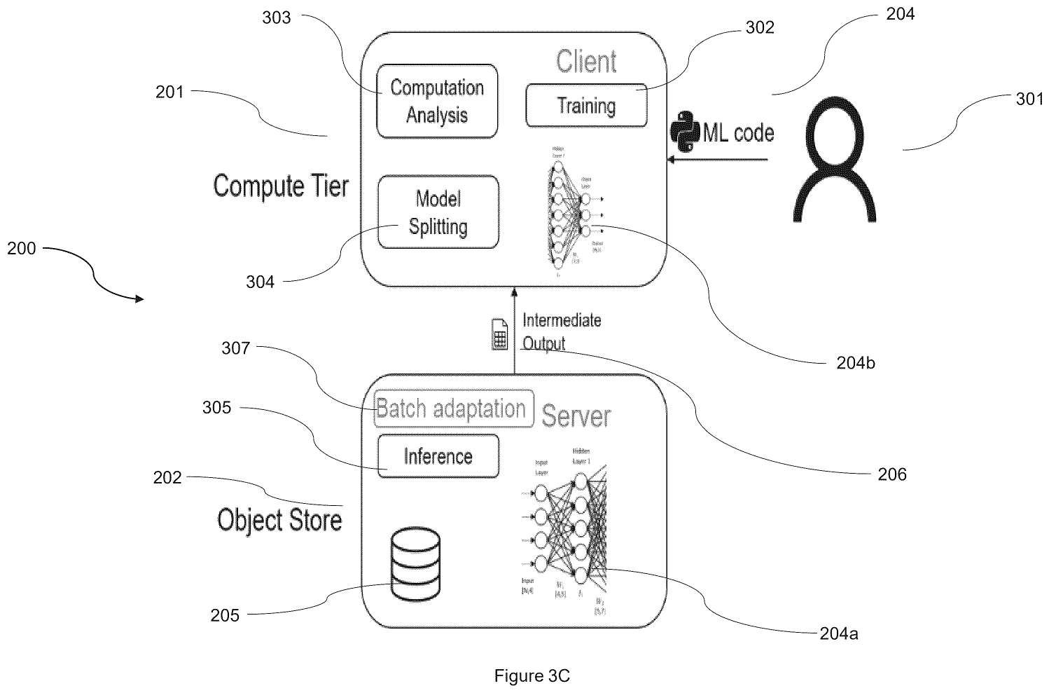

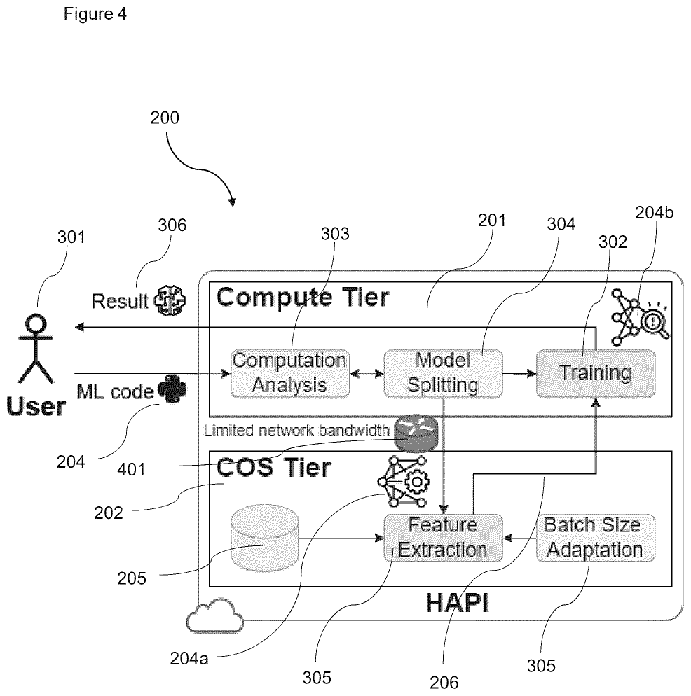

As shown in FIGS. 3A to 3C and FIG. 4, the computing apparatus 200 may be configured to obtain a machine learning code 204. In other words, the computing apparatus 200 may be configured to request and/or receive the machine learning code 204. The computing apparatus 200 may be configured to obtain the machine learning 204 from a user 301. The user 301 may be a user of the computing apparatus 200. The user 301 may require the computing apparatus 200 to execute the machine learning code 204. The user 301 may submit the machine learning code 301. The user 301 may be remote from the computing apparatus 200. The user 301 may communicate with the computing apparatus 200 through a network, such as the internet. The computing apparatus 200 may also obtain information about the user 301 along with the machine learning code 204. In this way, the computing apparatus 200 may know who or what the user 301 is.

The computing apparatus 200 may be configured to obtain one or more subsequent sets of machine learning codes 204. The computing apparatus 200 may be configured to split and/or execute the plurality of sets of machine learning codes 204 sequentially. The computing apparatus 200 may be configured to obtain one or more sets of machine learning codes 204 concurrently with the first set of machine learning code 204. The computing apparatus 200 may be configured to split and/or execute the plurality of sets of machine learning codes 204 concurrently. The plurality of machine learning codes 204 may be provided by the same user 301. Alternatively, the plurality of machine learning codes 204 may be provided by different users 301. In this way, the computing apparatus 200 may be able to deal with a plurality of requests for execution of machine learning code 204.

The machine learning code 204 may comprise a neural network (NN). In particular, the machine learning code 204 may comprise a deep neural network (DNN). The machine learning code 204 may comprise a plurality of NN layers, such that the machine learning code 204 is considered to be a DNN. The machine learning code 204 may comprise Python code. The machine learning code 204 may comprise transfer learning code. The machine learning code 204 may comprise an inference part of the machine learning code 204. The machine learning code 204 may comprise a training part of the machine learning 204. The inference part of the machine learning code 204 may be in earlier layers of the NN than the training part of the machine learning code 204. In particular, the inference part of the machine learning code 204 may be the NN layers directly before the layers of the training part of the machine learning 204. The inference part of the machine learning code 204 may comprise weights that are fixed, or frozen, during execution. The training part of the machine learning code 204b may comprise weights that are variable during execution.

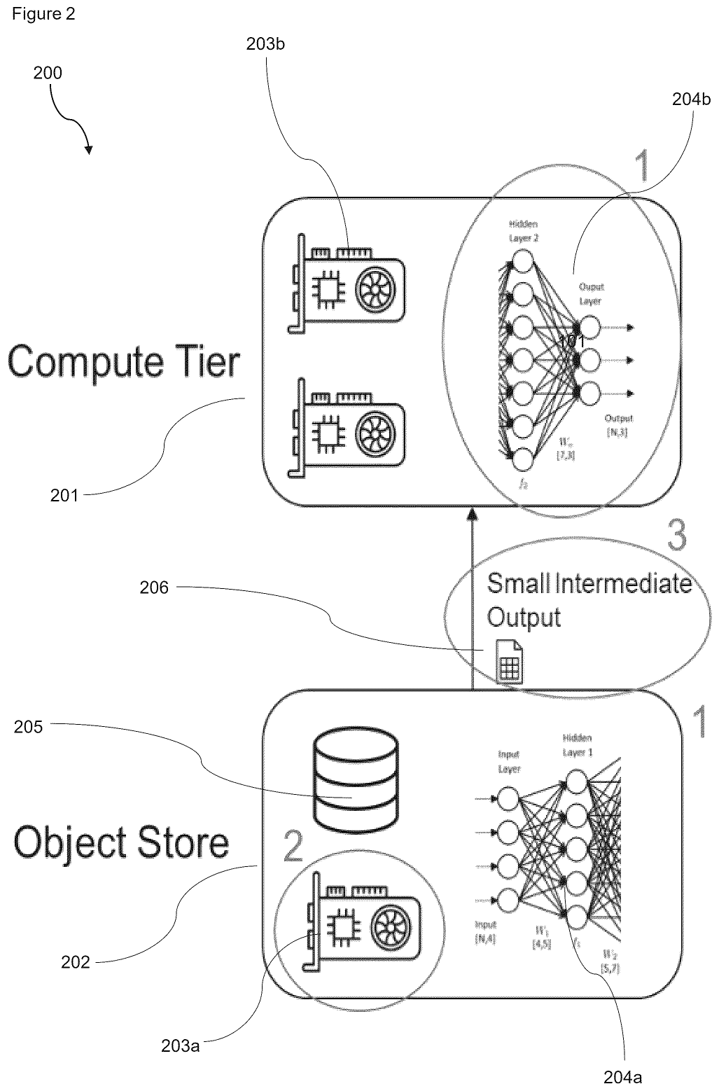

The computing apparatus 200 may comprise a client 201. As shown in FIG. 2. FIGS. 3A to 3C, and FIG. 4, the client 201 may be a computing tier. The client 201 may be configured to obtain the machine learning code 204. The user 301 may be remote from the client 201. The user 301 may communicate with the client 201 through a network, such as the internet. Alternatively, the user 301 may be located at the client 201.

The computing apparatus 200 may comprise a server 202. As shown in FIG. 2, FIGS. 3A to 3C, and FIG. 4, the server 202 may be a COS tier. The server 202 may be remote from the client 201. As shown in FIG. 4, the server 202 may communicate with the client 201 through a network 401. The network 401 may be a data centre network. In this case, the client 201 and the server 202 may be part of the same data centre. Alternatively, the network 401 may be the internet. In this case, the client 201 and the server 202 may be in different locations. The network 401 may have limited bandwidth.

As shown in FIG. 2, the client 201 may comprise one or more GPUs 203b. FIG. 2 illustratively shows two GPUs 203b. However, it is equally possible for the client 201 to comprise a different number of GPUs 203b. The GPUs 203b may be configured to execute machine learning code.

As shown in FIGS. 3A to 3C and FIG. 4, the client 201 may comprise a computational analysis module 303. The one or more of the GPUs 203b may be configured to carry out the processes of the computational analysis module 303.

The computational analysis module 303 may be configured to obtain the machine learning code 204. The computational analysis module 303 may be configured to analyse the machine learning code 204. The computational analysis module 303 may be configured to analyse the machine learning code 204 to determine characteristics about the machine learning code 204. For example, the computational analysis module 303 may be configured to analyse the machine learning code 204 to understand the workload of the machine learning code 204. The computational analysis module 303 may analyse the number of layers in the NN. The computational analysis module 303 may analyse the amount of memory to be used by the machine learning code 204. The computational analysis module 303 may analyse the amount of memory to be used by the weights of the machine learning code 204. The computational analysis module 303 may analyse the memory to be used by the input and the output of the machine learning code 204. The computational analysis module 303 may also obtain a configuration from the user 301 without necessitating an analysis. In this case, the computational analysis module 303 may obtain a freezing index, for example, the last layer of the inference part. The computational analysis module 303 may also obtain the training batch size from the user 301.

As shown in FIGS. 3A to 3C and FIG. 4, the client 201 may comprise a model splitting module 304. The model splitting module 304 may be carried out on a central processing unit (CPU) of the client 201. Alternatively, the one or more of the GPUs 203b may be configured to carry out the processes of the model splitting module 304.

The computing apparatus 200 may be configured to split the machine learning code 204 into a first part 204a and a second part 204b. In particular, the model splitting module 304 may be configured to split the machine learning code 204 into the first part 204a and the second part 204b. Once the machine learning code 204 is split, it may be saved onto the respective part of the computing apparatus 200, either the client 201 or the server 202. depending on the split.

The model splitting module 304 may be configured to split the machine learning code 204 in dependence on whether the first part 204a and the second part 204b comprise an inference part of the machine learning 204 and/or a training part of the machine learning code 204.

The first part of the machine learning code 204a may comprise at least part of the inference part of the machine learning code 204. The first part of the machine learning code 204a may comprise all of the inference part of the machine learning code 204. For example, part or all of the inference layers of the NN may be in the first part of the machine learning code 204a. Carrying out more of the inference part of the machine learning code on the server 201 may optimise the computing apparatus 200.

Preferably, the second part of the machine learning code 204b comprises all of the training part of the machine learning code 204. For example, all of the training layers of the NN may be in the second part of the machine learning code 204b. In some implementations, it may be required that all of the training layers of the NN are in the second part of the machine learning code 204b. Carrying out all of the training part of the machine learning code on the client 201 may optimise the computing apparatus 200. In particular, carrying out all of the training part of the machine learning code 204 on the client 201 may shift the more memory intense outputs onto the client 201, which may reduce the data transfer between the server 202 and the client 201. This is because, the training part of the machine learning code 204 is usually the cheaper part. Additionally, even if this is not the case, shifting more memory intense outputs onto the client 202 may also be correlated with larger data transfers. A reason why the entire training may be on the client may be related to the runtime of the application. Splitting training may require a backward pass split between the server and client which may be inefficient.

Generally, the inference part, also known as the feature extraction phase, of the machine learning code 204 (i.e., the first few layers of the DNN) is more demanding, in terms of (i) execution time. (ii) GPU memory, and (iii) output size, than the training phase (the latter layers of the DNN). Hence, pushing down, partially or entirely, feature extraction next to the server 202, also known as the COS, while running training on the compute tier, reduces the amount of data transferred over the network. Additionally, splitting the TL computation may enable decoupling the batch size of feature extraction from the training batch size. This decoupling may reduce the memory requirement of the TL computation and helps manage more efficiently the scarce and expensive GPU memory of the COS, allowing for concurrent users to better share the COS's GPUs.

It may be possible to push down both phases of the TL, feature extraction and training, next to storage. However, there may be limitations to this. Doing this may reduce the network traffic to the minimum possible, i.e., no data will be required to transfer during training: only at the end, the user might want to download the trained model from the COS. However, this solution may fail to decouple the batch size of feature extraction from that of training, leading to a choice between unsatisfactory options: limiting concurrency on the COS, leading to poor throughput, or running the risk of out-of-memory (OOM) errors.

The model splitting module 304 may work out the optimum, or as close to the optimum as possible, splitting of the machine learning code 204. For example, the model splitting module 304 may split the layers of the NN such that all of the training layers are to be executed on the client 201. The model splitting module 304 may also split the layers of the NN such that as many as possible of the inference layers are to be executed on the server 202. In some situations, it can be preferable that the split in the machine learning code 204 is between the last inference layer and the first training layer to reduce the traffic between the client 201 and the server 202. Although in other situations, this can result in the memory requirement on the server 202 being too high, or above a limit. In these other situations, it may be preferable to split in the machine learning code 304 between inference layers of the NN. In any event, the model splitting module 304 will be configured to split the machine learning code 204 in an efficient way such that the requirements on the traffic between the client 201 and the server 202 and the memory usage of the server 202 are balanced.

The model splitting module 304 may comprise a module splitting algorithm. The model splitting algorithm may comprises two phases: (i) the candidate selection, which may be guided purely by machine learning code 204, or model, properties; and (ii) the winner selection which selects one of the candidate layers and is guided by properties of the environment, i.e. the computing apparatus 200, namely the network bandwidth to the server 202.

The candidate selection may be based on the intermediate output sizes estimation made by the computational analysis module 303. The client 201 may choose layers with an output size which is smaller than the input size (scaled by the batch size). The main goal may be to reduce network traffic compared to sending the entire application input to the client 201.

The model splitting module 304 may be configured to split the machine learning code 204 in dependence on one or more characteristics of the machine learning code 204. In particular, the model splitting module 304 may obtain the characteristics about the machine learning code 204 from the computational analysis module 303. Alternatively, the model splitting module 304 may obtain the characteristics from another source other than the computational analysis module 303, such as the user 301.

The model splitting module 304 may use the characteristics of the machine learning code 204 to work out the optimum, or as close to the optimum as possible, splitting of the machine learning code 204 as described herein. For example, the model splitting module 304 may split the machine learning code 204 using the workload of the machine learning code 204. The model splitting module 304 may split the machine learning code 204 using the number of layers in the NN. The model splitting module 304 may split the machine learning code 204 using the amount of memory to be used by the machine learning code 204. The model splitting module 304 may split the machine learning code 204 using the amount of memory to be used by the weights of the machine learning code 204. The model splitting module 304 may split the machine learning code 204 using the memory to be used by the input and the output of the machine learning code 204.

The winner selection may be a dynamic approach that navigates the trade-off between two potentially opposing needs: (i) to push down as few layers as possible to save storage resources while (ii) reducing the time spent in network communication to improve user-perceived latency. The key to the success of the algorithm is based on observation that the layer output size decreases in general through the machine learning code 204, but non-monotonically. Hence, it may be possible to find layers early in the DNN with comparatively small output sizes. To best navigate this trade-off, the algorithm may choose the earliest candidate layer with an output size lower than C, where C is a function of the network bandwidth, essentially trading off an optimal splitting point, with respect to network transfers, for reduced pushdown to the COS.

The model splitting module 304 may be configured to split the machine learning code 204 in dependence on one or more characteristics about the computing apparatus 200. In particular, the model splitting module 304 may obtain the characteristics about the computing apparatus 200 from the computing apparatus 200. The model splitting module 304 may use the characteristics of the computing apparatus 200 to work out the optimum, or as close to the optimum as possible, splitting of the machine learning code 204 as described herein. For example, the model splitting module 304 may split the machine learning code 204 using characteristics about the bandwidth in the network 401 between the client 201 and the server 202. In this way, the bandwidth of the server may limit that amount of traffic between the client 201 and the server 202, which may in turn require more inference layers of the NN on the server 202.

The model splitting module 304 may be configured to inform the server 202 about how to split the machine learning code 204. The server 301 may be configured to fetch the dataset from the storage devices 205.

As shown in FIGS. 3A to 3C and FIG. 4, the client 201 may comprise a training module 302. The one or more of the GPUs 203b may be configured to carry out the processes of the training module 302.

The computing apparatus 200 may be configured to execute the second part 204b of the machine learning code 204. In particular, the training module 302 may be configured to execute the second part 204b of the machine learning code 204. In other words, the training module 302 may be configured to run the second part 204b of the machine learning code 204.

As described herein, the second part 204b of the machine learning code 204 may comprise the training part of the machine learning code 204. As such, the training module 204 may be configured to execute the training layers of the NN of the machine learning code 204. Additionally, as described herein, the second part 204b of the machine learning code 204 may comprise parts of the inference part of the machine learning code 204. As such, in such situations, the training module 204 may also be configured to execute parts of the inference layers of the NN of the machine learning code 204.

The computing apparatus 200 may be configured to execute the first part 204a of the machine learning code 204 for a synthesized data sample. In particular, an inference module 305 may be configured to execute the first part 204a of the machine learning code for a synthesized data sample. As shown in FIG. 4, the inference module 305 may also be known as a feature extraction module 305. Alternatively, or additionally, the training module 302 may be configured to execute the first part 204a of the machine learning code for a synthesized data sample. The inference module 305 and/or the training module 302 may be configured to generate a sample output from the synthesised data sample. The synthesized data sample may, for example, have a very small batch size, when compared to the batch size of the real data for the machine learning code 204. In this way, the inference module 305 and/or the training module 302 may run the first part 204a of the machine learning code 204 for a significantly smaller amount of data to sample what the output data from the first part 204a of the machine learning code 204 may be.

The model splitting module 304 may be configured to split the machine learning code 204 in dependence on the sample output. As shown in FIG. 4, the synthesized data sample may be provided from the model splitting module 304 to the training module 302 to generate the sample output. The sample output may then be used by the model splitting module 304 to provide guidance on the splitting of the machine learning code 204. The sample output may provide a predicted output of the training module 302 which may be used when assessing the splitting of the machine learning code 204.

In particular, the computation analysis module 303 may perform the profiling process to estimate the output size of each deep learning layer. To get the profiling data, computation analysis module 303 may run a forward pass with a synthesized data sample (i.e., with the same dimensions as the input data), using the inference model and keeping track of the per-layer memory consumption and the intermediate output sizes. One data sample (i.e., batch size of 1) may generally be sufficient, and hence, this process may be lightweight with respect to latency (a low number micro-seconds compared to a full sample) and memory consumption (a low number of MBs compared to a full sample). Based on this metadata, the model splitting module 304 may split the ML computation into two parts: one to be executed on the compute tier 201 (training computation) 204b and the other to be executed on the COS tier 202 (feature extraction computation) 204a.

Additionally, the model splitting module 304 may be configured to split the machine learning code 204 in dependence on an assessment between the sample output and the bandwidth of the network 401 that connects the client 201 and the server 202. In this way, the model splitting module 304 may be configured to split the machine learning code 204 in an efficient way such that the requirements on the traffic between the client 201 and the server 202 and the memory usage of the client 201 are balanced.

As shown in FIG. 2, the server 202 may comprise one or more GPUs 203a. FIG. 2 illustratively shows one GPU 203a. However, it is equally possible for the server 202 to comprise a different number of GPUs 203a. The GPUs 203a may be configured to execute machine learning code.

As shown in FIGS. 3A to 3C and FIG. 4, the server 202 may comprise an inference module 305. The one or more of the GPUs 203a may be configured to carry out the processes of the inference module 305. FIG. 4 refers to the inference module 305 as a feature extraction module 305, both terms may be used interchangeably.

The computing apparatus 200 may be configured to execute the first part 204a of the machine learning code 204. In particular, the inference module 305 may be configured to execute the first part 204a of the machine learning code 204. In other words, the inference module 305 may be configured to run the first part 204a of the machine learning code 204.

As described herein, the first part 204a of the machine learning code 204 may comprise the inference part of the machine learning code 204. As such, the inference module 305 may be configured to execute the inference layers of the NN of the machine learning code 204. Alternatively, as described herein, the second part 204b of the machine learning code 204 may comprise parts of the inference part of the machine learning code 204. As such, in such situations, the training module 302 may also be configured to execute parts of the inference layers of the NN of the machine learning code 204.

The computing apparatus 200 may be configured to execute the first part 204a of the machine learning code before the second part 204b of the machine learning code. In particular, the inference module 305 may execute the first part 204a of the machine learning code 204 before the training module 302 executes the second part 204b of the machine learning code 204. The computing apparatus 200 may be configured to send the intermediate outputs 206 from the server 202 to the client 201. The computing apparatus 200 may be configured to send the intermediate outputs 206 from the server 202 to the client 201 across the network 401.

As shown in FIG. 3C and FIG. 4, the server 202 may comprise a batch adaption module 307. The one or more of the GPUs 203a may be configured to carry out the processes of the batch adaption module 307.

A possible problem with executing code on the server 202 is that the amount of memory 205 on the server 202 may be limited, but there are many requests that can benefit from server-side pushdowns. The computing apparatus 200 may be configured to control the batch size (the ML computation granularity) in order to control the memory consumed by each request. The goal of batch adaptation may be to fit multiple client requests concurrently in the server memory.

The computing apparatus 200 may be configured to control the batch size of the first part 204a of the machine learning code 204. In particular, the batch adaption module 307 may be configured to control the batch size of the first part 204a of the machine learning code 204. Controlling the batch size of the first part 204a of the machine learning code 204 can enable the number of samples to be processed to be varied. This in turn can allow the amount of memory used by the first part 204a of the machine learning code 204 to be varied.

The batch adaption module 307 may be configured to control the batch size of the first part 204a of the machine learning code 204 in dependence on the memory 205 of the server 202 which would be occupied by the input and the output 206 of the first part 204a of the machine learning code 204. The batch adaption module 307 may estimate the memory requirements of the input and output 206 of the first part 204a of the machine learning code 204 and use this information to control the batch size. For example, if the input/output memory requirements are low, then the batch size may be increased. Alternatively, if the input/output memory requirements are high, such as above the memory 205 limit, the batch size may be reduced.

The batch adaption module 307 may be configured to control the batch size of the first part 204a of the machine learning code 204 in dependence on the memory 205 of the server 202 which would be occupied by the weights of the machine learning code 204. The batch adaption module 307 may estimate the memory requirements of the weights of the machine learning code 204 and use this information to control the batch size. For example, if the weights memory requirements are low, then the batch size may be increased. Alternatively, if the weights memory requirements are high, such as above the memory 205 limit, the batch size may be reduced.

The batch adaption module 307 may also be configured to control the batch size of the first part 204a of the machine learning code 204 in dependence on the memory 205 of the server 202 which would be occupied by both the input and the output 206 of the first part 204a of the machine learning code 204 and the weights of the machine learning code 204. In this way, the batch adaption module 307 may alter the batch size in dependence on all of the memory requirements.

As described herein, the computing apparatus 200 may be configured to obtain one or more subsequent, and/or concurrent, machine learning codes 204. The computing apparatus 200 may be configured to control the batch size of the first part 204a of each of the machine learning codes 204. In particular, the batch adaption module 307 may be configured to control the batch size of the first part 204a of each of the machine learning codes 204. Controlling the batch size of the first part 204a of each of the machine learning codes 204 can enable the number of samples to be processed to be varied for each of the machine learning codes 204. This in turn can allow the amount of memory used by each of the first part 204a of the machine learning codes 204 to be varied. This can able the batch adaption module 307 to prioritise certain machine learning codes 204 over others, and/or allow more machine learning codes 204 to be executed at the same time.

The batch adaption module 307 may be configured to control the batch size of the first part 204a of each of the machine learning codes 204 in dependence on the memory 205 of the server 202 which would be occupied by the input and the output 206 of the first part 204a of each of the machine learning codes 204. The batch adaption module 307 may estimate the memory requirements of the input and output 206 of the first part 204a of each of the machine learning codes 204 and use this information to control the batch size for each of the machine learning codes 204. For example, if the input/output memory requirements are low for a particular machine learning code 204, then the batch size may be increased and/or another machine learning code 204 may be executed at the same time. Alternatively, if the input/output memory requirements are high for a particular machine learning code 204, such as above the memory 205 limit, the batch size may be reduced, which may enable another machine learning code 204 to be executed at the same time.

The batch adaption module 307 may be configured to control the batch size of the first part 204a of each of the machine learning codes 204 in dependence on the memory 205 of the server 202 which would be occupied by the weights of each of the machine learning codes 204. The batch adaption module 307 may estimate the memory requirements of the weights of each of the machine learning codes 204 and use this information to control the batch size. For example, if the weights memory requirements are low for a particular machine learning code 204, then the batch size may be increased and/or another machine learning code 204 may be executed at the same time. Alternatively, if the weights memory requirements are high for a particular machine learning code 204, such as above the memory 205 limit, the batch size may be reduced, which may enable another machine learning code 204 to be executed at the same time.

The batch adaption module 307 may also be configured to control the batch size of the first part 204a of each of the machine learning codes 204 in dependence on the memory 205 of the server 202 which would be occupied by both the input and the output 206 of the first part 204a of each of the machine learning codes 204 and the weights of each of the machine learning codes 204. In this way, the batch adaption module 307 may alter the batch size of each of the machine learning codes 204 in dependence on all of the memory requirements.

The batch adaption module 307 may comprise a batch adaption algorithm. The batch adaptation algorithm may run repeatedly at the server. A new run of the algorithm may be triggered when two conditions hold: (i) there is available GPU memory 205 for new requests; and (ii) there exists at least one queued request that has not yet been accounted for in the previous runs of the algorithm.

It is possible that the server 202 receives several requests in quick succession. Thus, the server 202 may wait for new requests for a small amount of time, a small fraction of the time needed to serve one request. This approach may navigate the following trade-off. If the server delays the start of the algorithm too long, this might unnecessarily delay requests. However, if the server does not wait enough, arriving requests might have to wait for the current batch to finish processing (when there is insufficient memory).

The batch adaption algorithm may consider the already-running requests (i.e., at the time of applying the algorithm) but not the future requests. The goal of the algorithm is to maximize the GPU memory utilization over the existing requests while fitting as many of them inside the GPU memory. The output of the algorithm is the batch size to be used for each request, i.e., the storage batch size.

To choose the batch size, for each request, the server 201, specifically the batch adaption module 307, may solve the optimization problem in Equation 1:

$$max {\sum }_{r ∈ ℛ} {b}_{r} \times {r}_{} ( data ) + {r}_{} ( model ) \\ s . t . \\ {∀}_{r ∈ ℛ} {b}_{{r}_{m i n}} \leq {b}_{r} \leq {b}_{{r}_{m ax}} , \\ {\sum }_{r ∈ ℛ} {b}_{r} \times {r}_{} ( data ) + {r}_{} ( model ) \leq {total}_{} - ( occupied ) , \qquad ( 1 )$$

[symbol] is the set of requests in the queue, bᵣ is the batch size to be used for request r (i.e., the decision variables of the optimization problem), [symbol] .(data) is the amount of memory occupied by both the input and the intermediate outputs of the DNN model for request r, [symbol] .(model) is the amount of memory occupied by the DNN model weights for request r. [symbol] ₜₒₜₐₗ is the total amount of the GPU memory, [symbol] (occupied) is the amount of memory occupied by other already-running requests in addition to the estimation for the reserved memory for CUDA and the ML framework, and bᵣ_{ₘᵢₙ} and bᵣ_{ₘₐₓ} are the minimum and maximum bounds allowed for the batch size. bᵣ_{ₘₐₓ} is set by the client (typically, the same as the training batch size) while sending the request, whereas bᵣ_{ₘᵢₙ} is set by the operator.

The computing apparatus 200 may be configured to output a result 306 of the machine learning code 204. In particular, the client 201 may be configured to output the result 306 of the machine learning code 204. The training module 302 of the client 201 may be configured to output the result 306 of the machine learning code 204. The result may be from the end of the second part 204b of the machine learning code 204. The training module 302 may be configured to output the result 306 of the machine learning code 204 to the user 301. The training module 302 will output the result 306 of the machine learning code 204 to the same user 301 that supplied that machine learning code 204. In this way, the training module 302 may return the result 306 to the user 301.

As described herein, the computing apparatus 200 may be configured to obtain one or more subsequent, and/or concurrent, machine learning codes 204 which may be obtained from the same or different users 301. The training module 302 may be configured to output the result 306 of each the machine learning code 204 to the respective user 301 that supplied that machine learning code 204.

The computing apparatus 200 may provide a splitting algorithm to push down partial computation (the inference part of TL, e.g., feature extractions) into the storage layer 202 to achieve low-latency and to mitigate the network bottleneck. The splitting point in the ML model may depend on the model 204 and the environment. The proposed algorithm may automatically detect the splitting point. The splitting algorithm comprises two phases: (i) candidate selection: which choses layers at which splitting would be beneficial, which may be solely based on the training model; and (ii) winner selection, which selects one of the candidate layers to split at, which may be based on the environment properties.

The computing apparatus 200 may provide a batch size adaptation mechanism that can efficiently use the limited amount of storage-side memory 205 while also improving storage-side request concurrency. The proposed mechanism may allow the computing apparatus 200 to serve multiple client requests with the limited memory at storage side (the GPU memory 205). The mechanism may select the batch size to be used in each request.

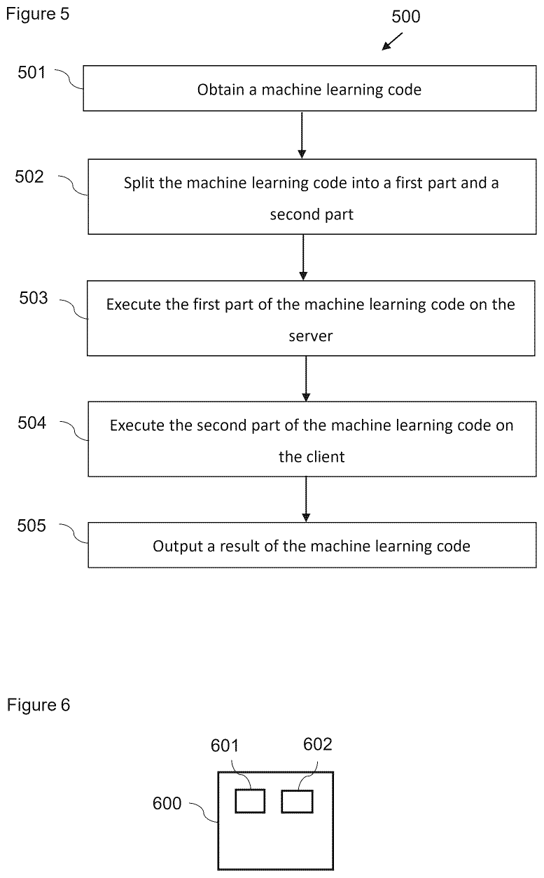

FIG. 5 summarises an example of a method 500 for executing machine learning code. At step 501, the method 500 comprises obtaining a machine learning code. At step 502, the method 500 comprises splitting the machine learning code into a first part and a second part. At step 503, the method 500 comprises executing the first part of the machine learning code on a server. At step 504, the method 500 comprises executing the second part of the machine learning code on a client. At step 505, the method 500 comprises outputting a result of the machine learning code.

An example of an apparatus 600 configured to implement the method 500 is schematically illustrated in FIG. 6. The computing apparatus 200 may comprise the apparatus 600. In particular, the client 201 and/or the server 202 may comprise the apparatus 600. The apparatus 600 may be implemented on an electronic device, such as a laptop, tablet, smart phone or TV.

The apparatus 600 comprises a processor 601 configured to process the datasets in the manner described herein. For example, the processor 601 may be implemented as a computer program running on a programmable device such as a Central Processing Unit (CPU). The apparatus 600 comprises a memory 602 which is arranged to communicate with the processor 601. Memory 602 may be a non-volatile memory. The processor 601 may also comprise a cache (not shown in FIG. 6), which may be used to temporarily store data from memory 602. The apparatus may comprise more than one processor and more than one memory. The memory may store data that is executable by the processor. The processor may be configured to operate in accordance with a computer program stored in non-transitory form on a machine-readable storage medium. The computer program may store instructions for causing the processor to perform its methods in the manner described herein.

It is clear that a person skilled in the art can make various modifications and variations to this disclosure without departing from the scope of this disclosure. This disclosure is intended to cover these modifications and variations of this disclosure provided that they fall within the scope of protection defined by the claims of this disclosure and their equivalent technologies.

1. A computing apparatus comprising a client and a server; the client and/or the server comprising one or more processors and a memory storing in non-transient form data defining program code executable by the one or more processors, wherein the program code, when executed by the one or more processors, causes the computing apparatus to:
obtain a machine learning code:
split the machine learning code into a first part and a second part;
execute the first part of the machine learning code on the server;
execute the second part of the machine learning code on the client; and
output a result of the machine learning code.

2. The computing apparatus according to claim 1, wherein the first part of the machine learning code comprises at least part of an inference part of the machine learning code.

3. The computing apparatus according to claim 2, wherein the first part of the machine learning code comprises all of the inference part of the machine learning code.

4. The computing apparatus according to claim 1, wherein the second part of the machine learning code comprises all of a training part of the machine learning code.

5. The computing apparatus according to claim 1, wherein the machine learning code is a transfer learning code.

6. The computing apparatus according to claim 1, wherein the apparatus is configured to split the machine learning code in dependence on one or more characteristics of the machine learning code.

7. The computing apparatus according to claim 6, wherein the apparatus is configured to execute the first part of the machine learning code for a synthesized data sample to generate a sample output, and split the machine learning code in dependence on the sample output.

8. The computing apparatus according to claim 1, wherein the apparatus is configured to split the machine learning code in dependence on one or more characteristics of the computing apparatus.

9. The computing apparatus according to claim 8, wherein the apparatus is configured to execute the first part of the machine learning code for a synthesized data sample to generate a sample output, and split the machine learning code in dependence on the sample output, and
wherein the apparatus is configured to split the machine learning code in dependence on an assessment between the sample output and a bandwidth of a network that connects the client and the server.

10. The computing apparatus according to claim 1, wherein the apparatus is configured to control a batch size of the first part of the machine learning code.

11. The computing apparatus according to claim 10, wherein the apparatus is configured to control the batch size of the first part of the machine learning code in dependence on one or more of:
the memory of the server which would be occupied by an input and an output of the first part of the machine learning code; and
the memory of the server which would be occupied by weights of the machine learning code.

12. The computing apparatus according to claim 1, wherein the apparatus is configured to obtain one or more subsequent machine learning codes.

13. The computing apparatus according to claim 12, wherein the apparatus is configured to individually control the batch size of the first part of each of the machine learning codes.

14. The computing apparatus according to claim 13, wherein the apparatus is configured to individually control the batch size of the first part of each of the machine learning codes in dependence on one or more of:
the memory of the server which would be occupied by an input and an output of the first part of each of the machine learning codes; and
the memory of the server which would be occupied by weights of each of the machine learning codes.

15. The computing apparatus according to claim 1, wherein the machine learning code is obtained from a user, and/or the result of the machine learning code is outputted to the user.

16. A method for executing machine learning code, wherein the method is applied to a computing device comprising a server and a client, wherein the method comprises:
obtaining a machine learning code:
splitting the machine learning code into a first part and a second part:
executing the first part of the machine learning code on the server;
executing the second part of the machine learning code on the client; and
outputting a result of the machine learning code.
